(19) United States
(12) Patent Application Publication
(10) Pub. No.: US 2004/0109318 A1
(43) Pub. Date: Jun. 10, 2004

(54) Reflector assembly for automated luminaires

(76) Inventor: Derek J. Nash, Christiansburg, VA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/434,484

(22) Filed: May 9, 2003

Related U.S. Application Data
(60) Provisional application No. 60/393,119, filed on Jul. 3, 2002.

(51) Int. Cl. F21V 29/00

(52) U.S. Cl. 362/294

(57) ABSTRACT

A reflector assembly includes a reflector having a wall terminating at opposite first and second ends. The wall has an inner reflecting surface defining an inner area and first and second openings at the first and second ends, respectively. The first opening is substantially smaller than the second opening. A third opening is proximate the second end. A lamp is supported within the inner area of the reflector at the first end with light from the lamp being directed towards the second opening. An air supply is in fluid communication with the third opening of the wall of the reflector so that air from the air supply enters the inner area of the reflector through the third opening and exhausts through the first opening of the reflector.

### RELATED APPLICATIONS

This application claims the benefit of U.S. Provisional Application Serial No. 60/393,119 to Carroll W. Smith et al., entitled Automated Luminaire and filed on Jul. 3, 2003, the subject matter of which is hereby incorporated by reference.

### FIELD OF THE INVENTION

The present invention relates to a reflector assembly for an automated luminaire that provides cooling to the lamp of the luminaire. More specifically, the present invention relates to a reflector assembly including a reflector and lamp in fluid communication with a fan allowing air from the fan to enter and exhaust form the reflector.

### BACKGROUND OF THE INVENTION

Conventional automated lighting fixtures, such as stage or spot lights, support lamps with a predetermined wattage. Heat generated from the fixture lamp is often not adequately dissipated by the fixture, thereby damaging components of the fixture, such as optical components including color wheels, focus assemblies, effects assemblies, gobo wheels, and the like. This is particularly true with higher wattage lamps. Some conventional lighting fixtures that support higher wattage lamps are bulky in order to adequately isolate the lamp and the heat generated thereby from the other components of the fixture. Additionally, most conventional lighting fixtures are designed to support only one type of lamp wattage because a higher wattage lamp would generate too much damaging heat in these conventional fixtures and a lower wattage lamp would be inefficient.

Examples of conventional lighting fixtures include U.S. Pat. Nos. 6,402,346 to Liao et al; 6,435,699 to Glowach, Sr. et al.; 6,340,237 to Koga et al.; 6,283,614 to Okada et al.; and 6,227,686 to Takahashi et al.; and U.S. patent application Publication Ser. Nos. 2002/0,141,188 to Basey; 2002/0,136,028 to Smith; and 2002/0,064,046, the subject matter of each of the above being hereby incorporated by reference.

### SUMMARY OF THE INVENTION

Accordingly, an object of the present invention is to provide a reflector assembly for an automated luminaire that provides cooling to the lamp sufficient to prevent damage to the optical components of the luminaire.

Another object of the present invention is to provide a reflector assembly for an automated luminaire that supports a high wattage lamp and also prevents damage to optical components of the luminaire.

Yet another object of the present invention is to provide a reflector assembly for an automated luminaire that both supports a high wattage lamp and allows for a compact design of the luminaire.

The foregoing objects are basically attained by a reflector assembly comprising a reflector including a wall terminating at opposite first and second ends. The wall has an inner reflecting surface defining an inner area and first and second openings at the first and second ends, respectively. The first opening is substantially smaller than the second opening. A third opening is proximate the second end. A lamp is supported within the inner area of the reflector at the first end with light from the lamp being directed towards the second opening. An air supply mechanism is in fluid communication with the third opening of the wall of the reflector so that air from the air supply mechanism enters the inner area of the reflector through the third opening and exhausts through the first opening of the reflector.

The foregoing objects are also attained by a reflector assembly comprising a reflector including a wall terminating at opposite first and second ends. The wall has an inner reflecting surface defining an inner area. First and second openings are disposed at the first and second ends, respectively. The first opening is substantially smaller than the second opening. A third opening is proximate the second end. A lamp is supported within the inner area of the reflector at the first end with light from the lamp being directed towards the second opening. A cover member extends between the wall of the reflector and an air supply mechanism. The cover member is in fluid communication with each of the third opening of the reflector and the air supply mechanism so that the cover member directs air from the air supply mechanism to the inner area of the reflector through the third opening, and the first opening of the reflector provides an exhaust for the air.

The foregoing objects are also attained by a reflector assembly comprising a plate having opposite first and second surfaces. A reflector is disposed on the first surface of the plate. The reflector includes a wall terminating at opposite first and second ends. The second end is coupled to the plate. The wall has an inner reflecting surface defining an inner area. First and second openings are disposed at the first and second ends, respectively. The first opening is substantially smaller than the second opening. A lamp is supported within the inner area of the reflector at the first end with light from the lamp being directed towards the second opening. An air supply mechanism is disposed on the first surface of the plate. A reflecting member is disposed on the second surface of the plate. The reflecting member is axially aligned with said reflector.

By designing the reflector assembly in the above fashion, the automated luminaire can have a compact design while also supporting a high wattage lamp and protecting the optical components of the luminaire from damage from heat.

Other objects, advantages and salient features of the invention will become apparent from the following detailed description, which, taken in conjunction with annexed drawings, discloses preferred embodiments of the present invention.

### BRIEF DESCRIPTION OF THE DRAWINGS

Referring to the drawings which form a part of this disclosure:

FIG. 1 is a perspective view of an automated luminaire including a reflector assembly in accordance with the preferred embodiments of the present invention;

FIG. 2 is an exploded perspective view of the automated luminaire illustrated in FIG. 1, showing the reflector assembly exploded from an optical assembly of the luminaire;

FIG. 3 is an exploded bottom perspective view of the optical assembly illustrated in FIG. 2, showing the reflector assembly in accordance with the first embodiment and lamp exploded from a frame of the optical assembly;

FIG. 4 is a side elevational view of the reflector assembly illustrated in FIG. 3, showing the lamp received in a reflector and a fan providing air to the reflector, each being supported on a plate, and a reflecting member supported on the plate opposite the reflector.

FIG. 5 is a top perspective view of the reflector assembly illustrated in FIG. 4, showing the reflecting member supported on the plate opposite the reflector;

FIG. 6 is a bottom perspective view of the reflector assembly illustrated in FIG. 4, showing the reflector and the fan joined by a cover member;

FIG. 7 is a top plan view of the reflector of the reflector assembly illustrated in FIG. 4;

FIG. 8 is an exploded perspective view of the reflector of the reflector assembly illustrated in FIG. 4, showing the cover member coupled to the reflector;

FIG. 9 is a perspective view of a reflector assembly in accordance with a second embodiment of the present invention, showing a reflector and fan mounted on a plate;

FIG. 10 is an exploded perspective view of the reflector of the reflector assembly illustrated in FIG. 9;

FIG. 11 is a top plan view of the reflector of the reflector assembly illustrated in FIG. 9;

FIG. 12 is a perspective view of a reflector assembly in accordance with a third embodiment of the present invention, showing a reflector and fan mounted on a plate;

FIG. 13 is a perspective view of the reflector of the reflector assembly illustrated in FIG. 12; and

FIG. 14 is a top plan view of the reflector of the reflector assembly illustrated in FIG. 12.

### DETAILED DESCRIPTION OF THE PREFERRED EMBODIMENTS

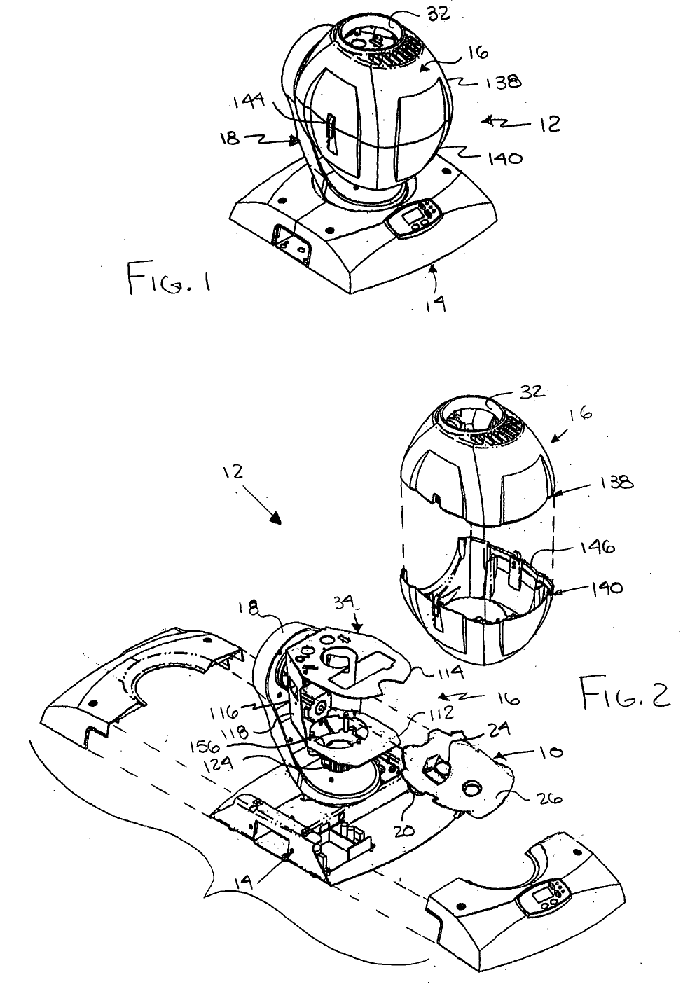

Referring to FIGS. 1-8, a reflector assembly 10 in accordance with a first embodiment of the present invention is preferably employed with an automated luminaire 12. Automated luminaire 12 generally includes a base 14, an optical assembly 16, and an arm 18 connecting base 14 and optical assembly 16 in the manner disclosed in commonly owned and co-pending U.S. patent application Ser. No. ______ to Carroll W. Smith et al. entitled Automated Luminaire With Light Beam Position Adjustment filed on May 9, 2003, the subject matter of which is hereby incorporated by reference. Reflector assembly 10 generally includes a reflector 20, an air supply mechanism 22, and a reflecting member 24, such as a hot mirror, each of which is supported by a plate 26. A cover member 28 that extends between reflector 20 and air supply mechanism 22 is preferably included with assembly 10. A lamp 30 is supported by a frame 34 of optical assembly 16 and extends into reflector 20 with reflector 20 and lamp 30 being aligned with an opening 32, that preferably supports a lens, in optical assembly 16 for outputting a light beam from lamp 30. Reflector assembly 10 can support lamps of different wattages, such as 400, 250 and 150 watts while also adequately cooling the lamp and preventing damage to other components supported by automated luminaire 12.

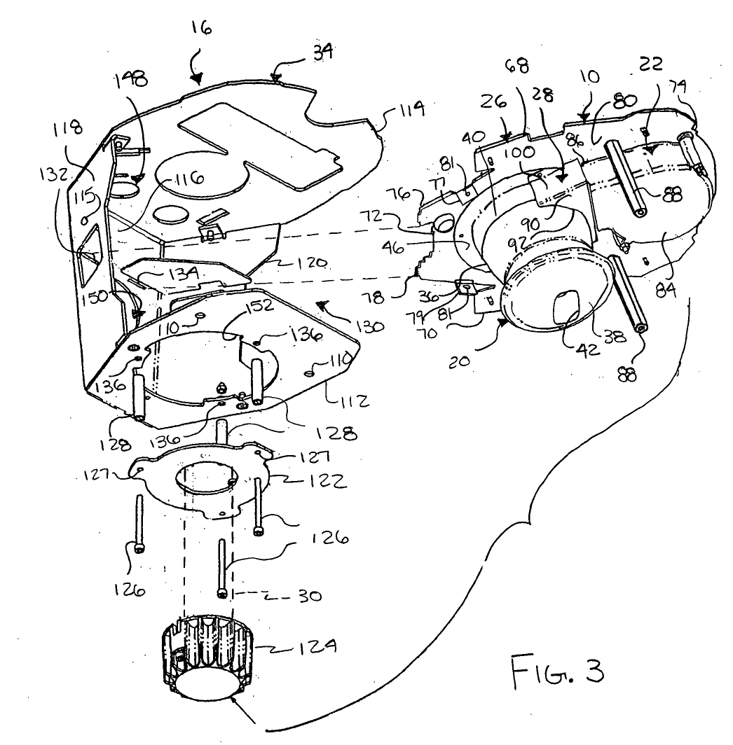

Reflector 20 includes a wall 36 with first and second ends 38 and 40, as seen in FIGS. 3-8. First and second openings 42 and 44 are disposed at said first and second ends 38 and 40, respectively, with second opening 44 being substantially larger than first opening 42. First opening 42 has a generally oval shape and second opening has a generally circular shape. An outwardly extending flange 46 extends from wall second end 38 and surrounds second opening 44. Lamp 30 extends through first opening 42 into an inner area 48 defined by reflector wall 20, as seen in FIG. 4, with light emitting from lamp 30 being directed towards second opening 44 by an inner reflecting surface 50 of wall 36. First opening 42 can have any shape other than oval, such as circular, as long as air can exhaust from inner area 48 with lamp 30 extending through first opening 42. Wall 36 preferably has a generally hour glass shape in cross section but can have other cross sectional shapes, such as a parabolic shape. Wall 36 can be formed by attaching first and second sections 51 and 52, as seen in FIG. 8, or wall 36 can be formed as a unitary one-piece member.

A third opening 54 is disposed in reflector wall 36 near second end 40 and second opening 44, as best seen in FIGS. 7 and 8, allowing air to enter reflector inner area 48. Third opening 54 is substantially smaller than second opening 44 and larger than first opening 42. Third opening 54 is elongated and defines first and second ends 56 and 58. Opening 54 follows the curvature of reflector wall 36, as best seen in FIG. 7.

A fourth opening 62 can be optionally included in reflector wall 54 near first end 38 of reflector wall 36, as seen in FIGS. 7 and 8. First and fourth openings 38 and 62 allow air to exhaust from reflector inner area 48. An optional deflector shield 64 can be supported on the outer perimeter of reflector wall 36, as seen in FIG. 8, for directing air out of fourth opening 62.

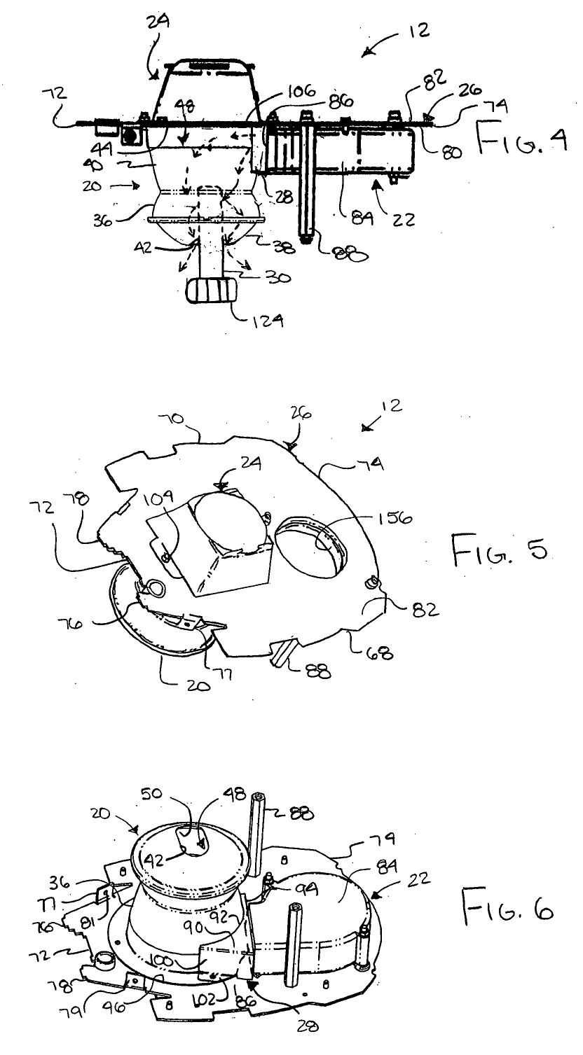

Reflector 20 is supported on plate 26, as seen in FIGS. 3 and 6. Plate 26 is preferably a flat metal piece having first and second sides 68 and 70 extending between a connection end 72 and an opposite curved end 74. Connection end 72 includes first and second locating tabs 76 and 78 for properly orienting plate 26 with respect to frame 34 of optical assembly 16 and first and second locating tabs 77 and 79 with fastener holes 81 four coupling plate 26 to frame 34. Plate 26 includes first and second opposite surfaces 80 and 82.

First surface 80 of plate 26 supports reflector 20 as well as air supply mechanism 22. Air supply mechanism 22 is preferably a fan or blower but can be any known mechanism for providing air or ventilation. Fan 22 includes a housing 84 with a single air outlet 86 directed towards reflector 20 at third opening 54. Fan 22 can have multiple air outlets as long as the outlets are directed towards reflector 20. Standoffs 88 are also included on plate first surface 80 for coupling plate 26 to frame 34 and providing rigidity to plate 26.

Cover member 28 extends between reflector 20 and fan 22, as best seen in FIGS. 3 and 6. Cover member 28 includes a main wall 90 with an inwardly curved edge 92, an opposite generally straight edge 94, and short and long edges 96 and 98 extending between curved and straight edges 92 and 94, as seen in FIG. 8. A side wall 100 extends from long edge 98. Cover member 28 is preferably secured to reflector 20 by fastener extensions 102 of cover member 28. Extensions 102 overly reflector flange 46 so that fasteners (not shown), such as screws or nails, can be inserted through aligned holes 102 of flange 46 and fastener extensions 100, as seen in FIGS. 6-8.

Disposed on second surface 82 of plate 26 is reflecting member 24, as best seen in FIG. 5. Reflecting member 24 is preferably a conventional hot mirror made of dichroic glass that reflects light in the infrared wavelengths and passes visible light. However, reflecting member 24 can be any reflecting material that passes visible light. Reflecting member 24 facilitates cooling of optical assembly 16 by directing heat away from the optics (not shown) of assembly 16 and towards reflector 20. Reflecting member 24 is secured to plate second surface 82 in any conventional manner, such as by fasteners 104. Reflecting member 24 is axially aligned with reflector 20, as seen in FIG. 4. An opening 106 in plate 26 provides access between reflector 20 and reflecting member 24, thereby allowing light from lamp 30 to shine through plate 26 and reflecting member 24.

As seen in FIGS. 2 and 3, reflector assembly 10 is mounted in frame 34 of optical assembly 16 and is preferably formed of sheet metal. Frame 34 includes first and second end walls 112 and 114, a main wall 116 extending between first and second end walls 112 and 114 and two secondary walls 118 and 120. A lamp adjustment plate 122 supports a lamp cap 124 and is mounted to first end wall 112 by fasteners 126. Fasteners 126 extend through corresponding holes 127 in lamp adjustment plate 122 and into fasteners holes 136 of frame end wall 112 to mount adjustment plate 122, lamp cap 124 and lamp 30 to frame 34. Spring members 128 are located between lamp adjustment plate 122 and frame first end wall 112, as best seen in FIG. 2. Lamp adjustment plate 122 pivots as fasteners 126 are inserted into frame end wall 112 via fastener holes 136 to angularly adjust the orientation of lamp 30. The pivoting allows the arc gap of the lamp 30 to be precisely located at the center of the reflector to provide greater output intensity and uniformity. Adjustment to lamp.30 is provided by changing the distance between lamp adjustment plate 122 and frame end wall 112 by inserting fasteners 126 through frame holes 136 by either a shorter or longer distance. To adjust the angular orientation of lamp 30, the distances of individual fasteners 126 with respect to frame end wall 112 are varied to provide angular adjustment of lamp 30 in the X-Y-Z axial directions. Fasteners 126 extend through spring members 128 such that spring members 128 will adjust as fasteners 126 and lamp adjustment plate 122 are adjusted with respect to frame end wall 112.

Lamp cap 122 is designed to accommodate different lamps 30, such as 150 watt, 250 watt or 400 watt lamps. An optical area 130 is defined between end walls 112 and 114, main wall 116 and secondary walls 118 and 120. Main wall 116 includes first and second slots 132 and 134 corresponding to first and second locating tabs 76 and 78 of plate 26. End wall 112 includes holes 110 corresponding to standoffs 88 of reflector assembly 10, as seen in FIG. 3. Each secondary wall 118 and 120 includes a hole 115 that aligns with holes 81 of connection tabs 77 and 79 of reflector assembly 10.

First and second covers 138 and 140 enclose frame 34 and the optics. First cover 138 has opening 32 allowing the light beam of from lamp 30 to shine therethrough. Opening 32 can include a lens. Preferably, covers 138 and 140 are snapped or latched together around frame 34 by a conventional latching mechanism 144, as best seen in FIG. 2. Plate 26 preferably has a shape that generally corresponds in shape to an outer edge 146 of second cover 140. Once plate 26 is mounted in frame 34 via locating tabs 76 and 78 and connecting slots 132 and 134, plate 26 segregates first and second covers 138 and 140 and divides frame 34 into hot and cool zones 148 and 150 (FIG. 3). Hot zone 148 is defined between the first surface 80 of plate 26 and frame end wall 112 and supports lamp 30, reflector 20 and fan 22. Cool zone 150 is defined between the second surface 82 of plate 26 and supports optics (not shown) of optical assembly 16, such as a color wheel, focus or effects assembly and the like.

Assembly and Operation

Referring to FIGS. 1-8, reflector assembly 10 is assembled by mounting reflector 20 and fan 22 to plate first surface 80 and reflecting member 24 to plate second surface 82. Reflector 20 and fan 22 are mounted on plate first surface 80 by fasteners extending through reflector flange 46 and fan housing 84, respectively. Reflector 20 and fan 22 are disposed near one another on plate first surface 80, and preferably adjacent, so that air outlet 86 of fan 22 directs air towards third opening 54 in reflector wall 36. Third opening 54 is sized to allow a pre-determined amount of air into the inner area 48 of reflector 20. The location of third opening 54 in reflector 20 relative to fan 22 and air outlet 86 is such that the air flow within inner area 48 of reflector 20 swirls, as indicated by arrows in FIG. 4, producing a turbulent air flow in inner area 48, thereby improving cooling. Reflecting member 24 is mounted to plate second surface 82 directly opposite reflector 20 so that reflecting member 24 and reflector 20 are axially aligned.

Cover member 28 is preferably used for directing air from fan 22 into reflector inner area 48 when employing a higher wattage lamp 30, such as a 400 watt lamp. Cover member 28 is coupled with reflector 20 so that curved edge 92 of cover member 28 abuts reflector wall 36, as seen in FIG. 8, and fastener extensions 102 are secured to reflector flange 46 by fasteners. Main wall 90 and side wall 100 of cover member 28 cover third opening 54 in reflector wall 36, as seen in FIG. 8. Straight edge 94 abuts or nearly abuts fan outlet 86, as seen in FIG. 6. An air passageway 154 is created between third opening 54 of reflector 20, fan outlet 86 and cover member 28.

Once reflector assembly 10 is assembled, reflector assembly 10 is mounted into frame 34, as seen in FIGS. 2 and 3. Specifically, locating tabs 76 and 78 of plate 26 are inserted into corresponding slots 132 and 134 of frame main wall 116 to properly orient plate 26 with respect to frame 34. Holes 81 of connection tabs 77 and 79 of plate 26 are aligned with holes 115 of frame secondary walls 118 and 120, and standoffs 88 are aligned with holes 110 of frame first end wall 112. Fasteners, such as screws, can ten be inserted and threaded into holes 115 of frame 34 and holes 81 of connection tabs 77 and 79, and threaded into holes 110 of frame 34 and standoffs 88 for securing reflector assembly 10 with respect to frame 34. Although fasteners are preferably used to secure reflector assembly 10 to frame 34, any known connection mechanism can be used such as welding or a snap engagement. Once mounted in slots 132 and 134, reflector 20 is aligned with lamp opening 152 in frame end wall 112. Lamp adjustment plate 122 and lamp cap 124 supporting lamp 30 are mounted to frame end wall 112 via fasteners 126 and fastener holes 136 disposed around lamp opening 152. Lamp 30 extends through lamp opening 152 and into reflector inner area 48 through first opening 42 of reflector 20 (FIG. 4). First and second covers 138 and 140 can then be latched together around frame 34 and reflector assembly 10 by latching mechanism 144 so that light from lamp 30 emits through opening 32 in first cover 138.

In operation, fan 22 directs air through fan outlet 86, through cover member 28 and into reflector inner area 48 through third opening 54 in reflector wall 36 to create a swirling air flow within reflector inner area 48, thereby cooling lamp 30. The air flow within reflector inner area 48 can be regulated by using a thermister (not shown) mounted in frame 34 that reads the air temperature and changes the fan 22 speed based on that reading to maintain an optimal temperature range. Optionally, to facilitate maintaining a cool temperature in cool zone 150 and also cooling lamp 30 within hot zone 148, fan 22 can draw cool air from cool zone 150 through an opening 156 in plate 26 into hot zone 148, thereby keeping the optics in cool zone 150 cool and exhausting cool air into the hot zone 148 to cool lamp 30. Power is provided to lamp 30 and reflector assembly 10 by a power supply supported in base 14 and wired to optical assembly 16 through arm 18.

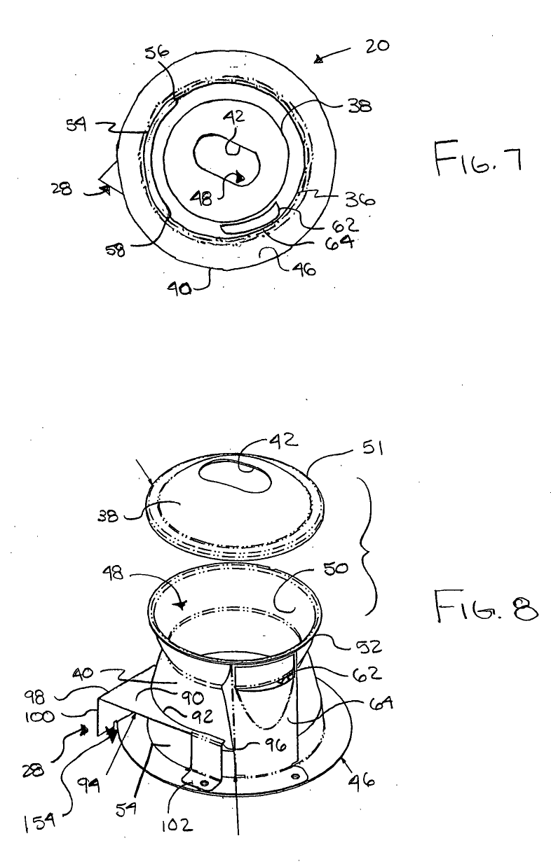

Embodiment of FIGS. 9-11

Referring to FIGS. 9-11, a reflector assembly 210 of a second embodiment of the present invention is substantially the same as reflector assembly 10 of the first embodiment except that reflector assembly 210 does not include cover member 28 and fourth opening or exhaust 62 in reflector 20. Reflector assembly 210 is preferably used with a lamp of lower wattage, than the lamp used with reflector assembly 10, such as 250 watts. To facilitate description, the same reference numerals used in describing reflector assembly 10 are used to describe reflector assembly 210 with the addition of 200. Reflector assembly 210 includes a reflector 220 and a fan 222 disposed on a first surface 280 of a plate 226, and a reflecting member (not shown) similar to reflector member 24 disposed on a second surface opposite first surface 280 of plate 226.

Reflector 220 includes a reflector wall 236 having first, second and third openings 242, 244 and 254. First opening 242 can be circular in shape versus first opening 42 of reflector assembly 10, which has a generally oval shape. However, first opening 242 can be any shape as long as air can exhaust therethrough while a lamp extends through first opening 242 into reflector 220. Fan 222 includes a housing 284 and an air outlet 286.

Reflector assembly 210 is assembled in the same manner as described above with respect to reflector assembly 10. Fan 222 is disposed on plate 226 so that air outlet 286 is directed towards reflector third opening 254, as best seen in FIG. 9, to provide air flow through third opening 254 and an air exhaust through first opening 242. Reflector assembly 210 mounts in frame 34 of optical assembly 16 in the same manner as reflector assembly 10 via plate connection end 272 providing hot and cool zones 148 and 150 as described above.

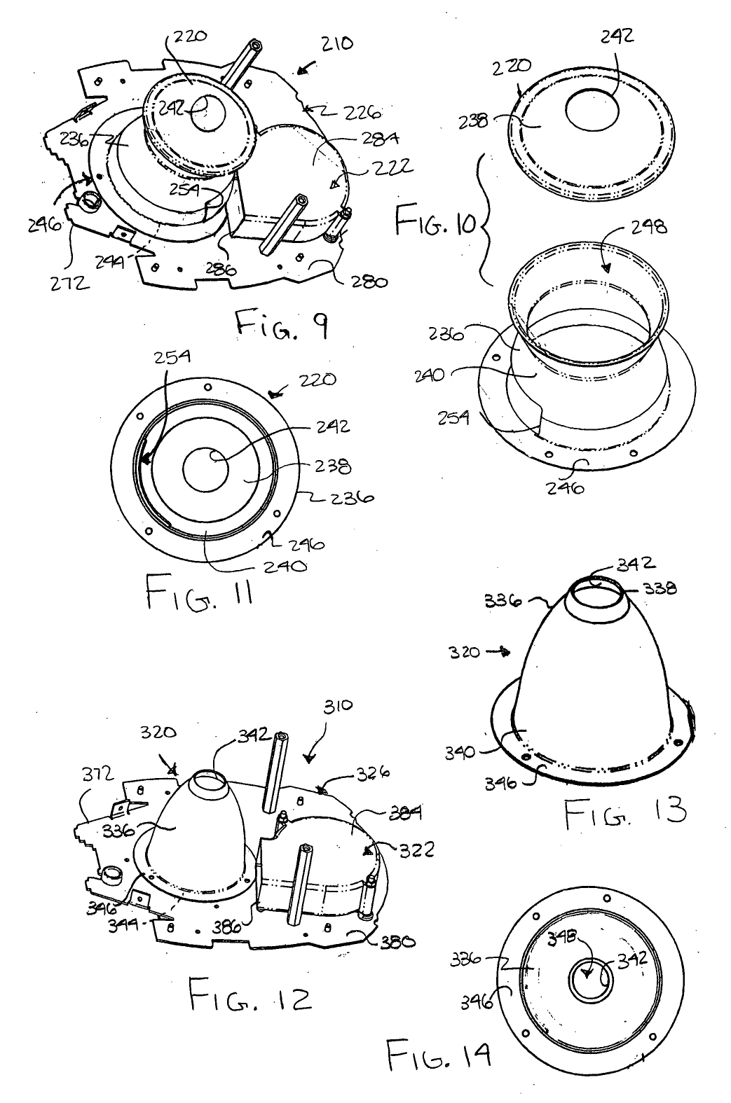

Embodiment of FIGS. 12-14

Referring to FIGS. 12-14, a reflector assembly 310 of a third embodiment of the present invention is substantially the same as reflector assembly 10 of the first embodiment except that reflector assembly 310 does not include cover member 28, third opening 54 in reflector 20, and fourth opening or exhaust 62 in reflector 20. Reflector assembly 310 is preferably used with a lamp of lower wattage, such as 150 watts, than the lamp used with either reflector assembly 10 or reflector assembly 210. To facilitate description, the same reference numerals used in describing reflector assembly 10 are used to describe reflector assembly 310 with the addition of 300. Reflector assembly 310 includes a reflector 320 and a fan 322 disposed on a first surface 380 of a plate 326, and a reflecting member (not shown) similar to reflector member 24 disposed on a second surface opposite first surface 380 of plate 326.

Reflector 320 includes a reflector wall 336 having first and second openings 342 and 344. Reflector wall 336 preferably has a parabolic cross sectional shape versus the hour glass shape of reflectors walls 36 and 236 of the first and second embodiments. First and second openings 342 and 344 are generally circular. However, first opening 342 can be any shape as long as air can exhaust therethrough while a lamp extends through first opening 342 into reflector 320. Fan 322 includes a housing 384 and an air outlet 386.

Reflector assembly 310 is assembled in the same manner as described above with respect to reflector assembly 10. Fan 322 is disposed on plate 326 so that air outlet 286 is directed towards reflector wall 336, as best seen in FIG. 12, to provide cooling to reflector 320. Reflector assembly 310 mounts in frame 34 of optical assembly 16 in the same manner as reflector assembly 10 providing hot and cool zones 148 and 150 as described above.

While particular embodiments have been chosen to illustrate the invention, it will be understood by those skilled in the art that various changes and modifications can be made therein without departing from the scope of the invention as defined in the appended claims.

What is claimed is:

1. A reflector assembly, comprising:
a reflector including a wall terminating at opposite first and second ends, said wall having an inner reflecting surface defining an inner area and having first and second openings at said first and second ends, respectively, and a third opening proximate said second end, said first opening being substantially smaller than said second opening;
a lamp supported within said inner area of said reflector at said first end with light from said lamp being directed towards said second opening; and
an air supply in fluid communication with said third opening of said wall of said reflector,
whereby air from said air supply mechanism enters said inner area of said reflector through said third opening and exhausts through said first opening of said reflector.

2. A reflector assembly according to claim 1, wherein
said air supply is adjacent said reflector.

3. A reflector assembly according to claim 1, wherein
said air supply comprises a fan having an air outlet directed towards said third opening of said reflector.

4. A reflector assembly according to claim 1, wherein
said second end of said reflector includes an outwardly extending flange, said flange extending around said second opening.

5. A reflector assembly according to claim 1, wherein
said third opening is larger than said first opening and smaller than said second opening.

6. A reflector assembly according to claim 1, wherein
each of said reflector and said air supply is supported on a plate.

7. A reflector assembly according to claim 1, wherein
said wall of reflector includes a fourth opening providing another exhaust for the air from said air supply.

8. A reflector assembly, comprising:
a reflector including a wall terminating at opposite first and second ends, said wall having an inner reflecting surface defining an inner area, first and second openings at said first and second ends, respectively and a third opening proximate said second end, said first opening being substantially smaller than said second opening;
a lamp supported within said inner area of said reflector at said first end with light from said lamp being directed towards said second opening; and
a cover member extending between said wall of said reflector and an air supply, and said cover member being in fluid communication with said third opening of said reflector and said air supply,
whereby said cover member directs air from said air supply to said inner area of said reflector through said third opening, and said first opening of said reflector provides an exhaust for the air.

9. A reflector assembly according to claim 8, wherein
said air supply is adjacent said reflector.

10. A reflector assembly according to claim 8, wherein
said air supply is a fan having an air outlet directed towards said third opening of said reflector.

11. A reflector assembly according to claim 8, wherein
said second end of said reflector includes an outwardly extending flange, said flange extending around said second opening.

12. A reflector assembly according to claim 8, wherein
said third opening is larger than said first opening and smaller than said second opening.

13. A reflector assembly according to claim 8, wherein
said cover member has a main wall abutting said wall of said reflector and covering said third opening, and a side wall extending from said main wall; and
an air passageway extends between said main and side walls.

14. A reflector assembly according to claim 13, wherein
said main wall of said cover member includes a curved edge substantially corresponding to a curvature of said wall of said reflector.

15. A reflector assembly according to claim 14, wherein
said main wall includes a second edge opposite said curved edge, said second edge meeting an air outlet of said air supply.

16. A reflector assembly according to claim 14, wherein
said wall of said reflector includes a fourth opening providing another exhaust for the air from said air supply.

17. A reflector assembly, comprising:
a plate having opposite first and second surfaces;
a reflector disposed on said first surface of said plate, said reflector including a wall terminating at opposite first and second ends, said second end being coupled to said plate, said wall having an inner reflecting surface defining an inner area and having first and second openings at said first and second ends, respectively, said first opening being substantially smaller than said second opening;
a lamp supported within said inner area of said reflector at said first end with light from said lamp being directed towards said second opening;
an air supply disposed on said first surface of said plate; and
a reflecting member disposed on said second surface of said plate, said reflecting member being axially aligned with said reflector.

18. A reflector assembly according to claim 17, wherein
said wall of said reflector includes a third opening proximate said second end; and
said air supply is in fluid communication with said third opening.

19. A reflector assembly according to claim 18, wherein
a cover member extends between said wall of said reflector and said air supply, said cover member being in fluid communication with each of said third opening of said reflector and said air supply.

20. A reflector assembly according to claim 17, wherein
said air supply is adjacent said reflector.

21. A reflector assembly according to claim 17, wherein
said air supply is a fan having an air outlet directed towards said reflector.

22. A reflector assembly according to claim 17, wherein
said plate includes an opening aligned with said reflector and said reflecting member.

23. A reflector assembly according to claim 17, wherein
said wall of said reflector includes an outwardly extending flange at said second end, said flange being coupled to said first surface of said plate.

24. A reflector assembly according to claim 17, wherein
said plate is coupled to a support frame and divides said frame into first and second areas;
said first area accommodates said reflector and said air supply; and
said second area accommodates said reflecting member.

25. A reflector assembly according to claim 17, wherein
said reflector member is a mirror.

26. A reflector assembly according to claim 17, wherein
said wall of said reflector includes a fourth opening providing another exhaust for the air from said air supply.

27. A reflector assembly according to claim 17, wherein
said plate includes connecting elements for mounting said plate within a support frame.
